(19) United States
(12) Patent Application Publication
(10) Pub. No.: US 2016/0241131 A1
(43) Pub. Date: Aug. 18, 2016

(54) INTEGRATED BOOST ASYMMETRICAL HALF BRIDGE POWER CONVERSION TOPOLOGY

(71) Applicant: GE Lighting Solutions, LLC, East Cleveland, OH (US)

(72) Inventors: Giampaolo Carli, Lachine (CA); Sheldon S. Williamson, Oshawa (CA); Arun Damodharan, Oshawa (CA)

(21) Appl. No.: 14/623,534

(22) Filed: Feb. 17, 2015

(51) Int. Cl. H02M 1/42; H02M 3/24

(52) U.S. Cl. CPC H02M 1/42; H02M 3/24

(57) ABSTRACT

A method of operating a DC-DC converter includes providing a first error signal to a frequency controller, the first error signal derived from a difference between a discontinuous conduction mode input current and a sinusoidal current reference, providing a second error signal to a duty cycle controller, the second error signal derived from a difference between an output signal and an output reference signal, and combining a frequency signal from the frequency controller and a duty cycle signal from the duty cycle controller to produce a complimentary pulse train for driving the DC-DC converter to both control an input power factor and regulate the output signal.

The disclosed exemplary embodiments relate generally to power conversion circuitry, and more particularly to a single conversion stage that provides both power factor correction and output regulation.

### BACKGROUND OF THE INVENTION

Several schemes for merging output regulation and input power factor correction functions in a single power conversion stage are already in existence. For example, Boost Integrated Flyback (BIFRED), Boost Integrated Buck (BIBRED), Boost Integrated Asymmetric Half Bridge and other related topologies may attempt to provide both output power factor correction and output regulation. The Boost Integrated topologies are advantageous, particularly with respect to a classical Flyback converter, in that they are capable of providing low output ripple current whereas the Flyback converter typically produces more ripple current because the capacitors in the Flyback converter topology are generally oversized and are located on the output. In contrast, the Boost-Integrated topologies filter ripple using the internal link capacitors which are disconnected from the output.

Garcia, “Single Phase Power Factor Correction: A Survey,” IEEE Transactions on Power Electronics, vol. 18, No. 3, May 2003, describes different single stage boost-integrated topologies. However, none of the topologies include frequency modulation. U.S. Pat. No. 5,822,198, filed on 21 Jun. 1996 and issued on 13 Oct. 1998, describes a boost integrated asymmetrical half bridge topology but only varies duty cycle. Carli et al., “On the Elimination of Pulsed Output Current In Z-Loaded Chargers/Rectifiers,” Twenty-Fourth Annual IEEE Applied Power Electronics Conference and Exposition, 2009, provides a double modulation scheme for tight input and output control but does not modulate frequency. Jovanovic, “Reduction of Voltage Stress in Integrated High-Quality Rectifier-Regulators by Variable-Frequency Control,” Ninth Annual Applied Power Electronics Conference and Exposition, 1994, describes a frequency modulation scheme, but only to minimize stress on the bulk capacitors as opposed to improving power factor correction and total harmonic distortion.

Furthermore, the described Boost-Integrated topologies generally provide only partial power factor correction rather than a more precise power factor correction. It would be advantageous to provide a power conversion stage that precisely controls both input power factor and output regulation.

### SUMMARY OF THE INVENTION

The disclosed embodiments are directed to a method of operating a DC-DC converter, including providing a first error signal to a frequency controller, the first error signal derived from a difference between a discontinuous conduction mode input current and a sinusoidal current reference, providing a second error signal to a duty cycle controller, the second error signal derived from a difference between an output signal and an output reference signal, and combining a frequency signal from the frequency controller and a duty cycle signal from the duty cycle controller to produce a complimentary pulse train for driving the DC-DC converter to both control an input power factor and regulate the output signal.

Some aspects of the disclosed embodiments include using the frequency controller to generate the frequency signal from the first error signal.

Certain aspects of the disclosed embodiments include using the duty cycle controller to generate the duty cycle signal from the second error signal.

At least one aspect of the disclosed embodiments includes operating the frequency and duty cycle controllers together as a multiple input multiple output controller, and using the multiple input multiple output controller to calculate frequency and duty cycle values that are decoupled so that the first error signal does not affect the regulation of the output signal and the second error signal does not affect the input power factor.

One or more aspects of the disclosed embodiments includes operating the frequency and duty cycle controllers together as a multiple input multiple output controller, and using the multiple input multiple output controller to calculate frequency and duty cycle values that are decoupled so that the first error signal only affects the input power factor and the second error signal only affects the regulation of the output signal.

The disclosed embodiments may also include optimizing a value of a voltage across a bulk capacitor of the DC-DC converter by determining a combination of frequency and duty cycle values that controls the input power factor control, output power regulation, while providing a voltage across the bulk capacitor that maintains a discontinuous conduction mode operation.

The disclosed embodiments are further directed to a DC-DC converter including a frequency controller configured to receive a first error signal derived from a difference between a discontinuous conduction mode input current and a sinusoidal current reference, a duty cycle controller configured to receive a second error signal derived from a difference between an output signal and an output reference signal, and a modulator configured to combine a frequency signal from the frequency controller and a duty cycle signal from the duty cycle controller to produce a complimentary pulse train for driving the DC-DC converter to both adjust an input power factor and regulate the output signal.

In some aspects of the disclosed embodiments, the frequency controller is configured to generate the frequency signal from the first error signal.

In certain aspects of the disclosed embodiments, the duty cycle controller is configured to generate the duty cycle signal from the second error signal.

At least one aspect of the disclosed embodiments includes a multiple input multiple output controller comprising the frequency and duty cycle controllers, wherein the multiple input multiple output controller is configured to calculate frequency and duty cycle values that are decoupled so that the first error signal does not affect the regulation of the output signal and the second error signal does not affect the input power factor.

One or more aspects of the disclosed embodiments includes a multiple input multiple output controller comprising the frequency and duty cycle controllers, wherein the multiple input multiple output controller is configured to calculate frequency and duty cycle values that are decoupled so that the first error signal only affects the input power factor and the second error signal only affects the regulation of the output signal.

The disclosed embodiments may include an optimizer configured to optimize a value of a voltage across a bulk capacitor of the DC-DC converter by determining a combination of frequency and duty cycle values that controls the input power factor control, output power regulation, while at the same time providing a voltage across the bulk capacitor that maintains a discontinuous conduction mode operation.

### BRIEF DESCRIPTION OF THE DRAWINGS

FIG. 1 shows an exemplary power conversion circuit according to the disclosed embodiments;

FIG. 2 shows a schematic block diagram of an exemplary power conversion circuit according to the disclosed embodiments;

FIG. 3 shows a schematic block diagram of another exemplary power conversion circuit according to the disclosed embodiments;

FIG. 4 illustrates operations of a controller for decoupling frequency and duty cycle parameters used to drive the power conversion circuit; and

FIG. 5 illustrates a version of a controller that includes the controller of FIG. 4.

### DETAILED DESCRIPTION OF THE INVENTION

The disclosed embodiments are directed to a power conversion topology that utilizes a single conversion stage for both power factor correction and output regulation by modulating both duty cycle and frequency. The modulation scheme also results in minimized voltage stress on the bulk capacitor and reduced and better controlled RMS current in the switching transistor.

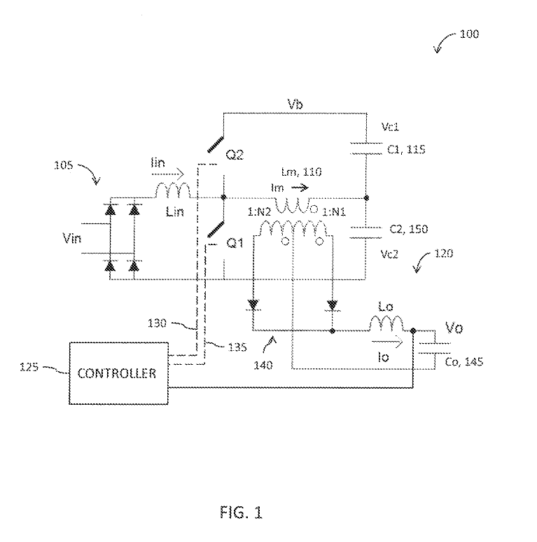

FIG. 1 shows an exemplary power conversion circuit 100 according to the disclosed embodiments. While the present embodiments are described with respect to an asymmetrical half bridge power conversion topology, the presently disclosed embodiments may be applicable to any topology where input current and output current (or voltage) are both sensitive to both duty cycle and frequency, including, for example, most discontinuous mode topologies.

The exemplary power conversion circuit 100 includes a rectifier 105, an input boost inductor Lin, switches Q1 and Q2, a transformer 110, a bulk capacitor 115, a controller 125, and a rectifying and filtering circuit 120, comprising a half wave rectifier 140, an inductor Lo and a capacitor 145. Controller 125 receives Vo as an input and generates complimentary pulse trains 130, 135 for switching Q1 and Q2. During a first interval, with Q1 closed and Q2 open, input boost inductor Lin charges by way of current flowing from the rectifier 105 through input boost inductor Lin and returning to the rectifier 105 through switch Q1. During a second interval with Q1 open and Q2 closed, bulk capacitor is charged by way of current flowing from input boost inductor Lin through Q2 to bulk capacitor 115. During the first interval, with Q1 closed and Q2 open, bulk capacitor 115 drives a primary winding of transformer 110 of exemplary power conversion circuit 100 in one direction, and during the second interval with Q1 open and Q2 closed, bulk capacitor 115 drives the primary winding in the opposite direction. The resulting alternating current on the secondary winding is converted to direct current by the rectifying and filtering circuit 120.

The controller 125 receives Vo as an input and adjusts both the frequency and duty cycle of the complimentary pulse trains 130, 135. The transfer function from the bulk voltage Vb to the output current is well known and has little or no dependency on frequency, as long as the current in inductor Lo is kept in continuous conduction mode (CCM). However, the current in input boost inductor Lin is generally kept in discontinuous conduction mode (DCM), and as such, the average current drawn from the line is affected by both frequency and duty cycle. The simplest embodiment of the control method includes a controller 125 that modulates the duty cycle of the complimentary pulse trains 130, 135 to control and suppress the output current ripple through the action of the asymmetrical half bridge, and to modulate the frequency of the complimentary pulse trains 130, 135 to control the input current for power factor correction through the action of boost inductor Lin.

It should be noted that in some embodiments, more than one combination of frequency and duty cycle may produce the same input power correction and output regulation. Thus, different combinations of frequency and duty cycle may be selected to control other operational parameters, for example bulk capacitor voltage, in order to improve reliability. It should also be noted that in some embodiments, frequency and duty cycle are coupled control variables, in that the duty cycle affects both the output regulation and the input power factor, and the frequency also indirectly affects both the input power factor and the output regulation. Other embodiments operate under a control scheme that actively seeks to decouple the frequency and duty cycle control variables, by generating two alternate control variables such that one control variable affects only the output regulation and the other control variable only affects the input power factor.

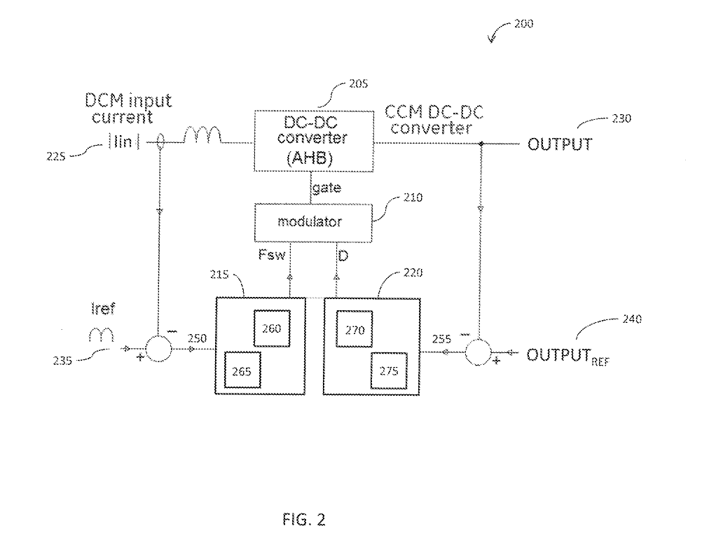

FIG. 2 shows a schematic block diagram of an exemplary power conversion circuit 200 according to the disclosed embodiments. The exemplary power conversion circuit 200 includes an asymmetric half bridge DC-DC converter 205, similar to power conversion circuit 100 (FIG. 1), a modulator 210, a frequency controller 215, and a duty cycle controller 220. The asymmetric half bridge DC-DC converter 205 receives an input current 225 that is actively kept in Discontinuous Conduction Mode (DCM) and provides a Continuous Conduction Mode (CCM) regulated output current 230. The discontinuous conduction mode input current 225 is compared to a sinusoidal current reference 235 and the error signal 250 is provided to frequency controller 215. The output signal current or voltage 230 is compared to an output reference 240 and the error signal 255 is provided to duty cycle controller 220. At the same time, frequency controller 215 provides a frequency signal Fsw to modulator 210 for correcting the power factor of the input of the DC-DC converter 205. The duty cycle controller 220 provides a duty signal D with a particular duty cycle to the modulator 210 for regulating the output current or voltage 230. The modulator combines the frequency signal Fsw and duty cycle signal D controller 220 provides a gate signal comprising complimentary pulse trains for driving the DC-DC converter 205.

Frequency controller 215 and duty cycle controller 220 may be implemented as analog controllers and may include suitable passive and active components for conditioning error signals 250 and 255, respectively. In at least one aspect of the disclosed embodiments, frequency controller 215 and duty cycle controller 220 may be implemented as digital controllers 260, 270 under the control of one or more programs stored on computer readable media, for example, memories 265, 275. The memories may include magnetic media, semiconductor media, optical media, or any media which is readable and executable by a digital controller. In one or more embodiments, the frequency controller 215 and duty cycle controller 220 may be implemented as any combination of analog and digital components.

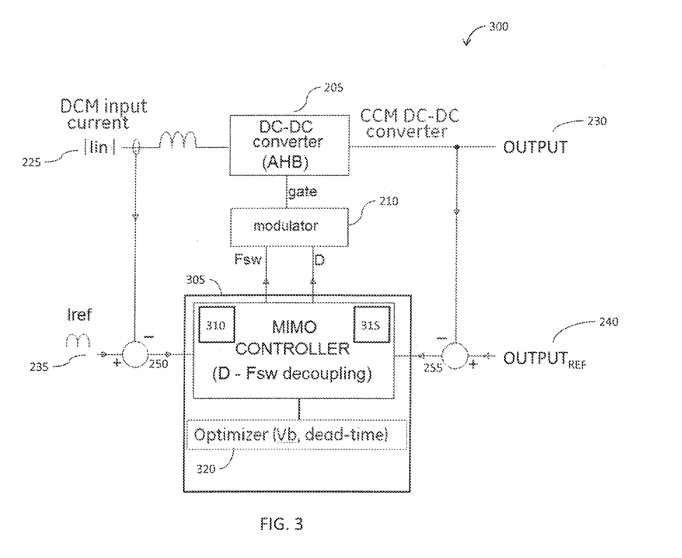

FIG. 3 shows a schematic block diagram of another exemplary power conversion circuit 300 according to the disclosed embodiments. The exemplary power conversion circuit 300 includes a Multiple Input Multiple Output (MIMO) controller 305 instead of separate frequency and duty cycle controllers. While the frequency controller 215 and duty cycle controller 220 produce signals that operate to precisely adjust the input power factor and precisely regulate the output voltage or current, in the embodiment of FIG. 2, changing the frequency used to drive the switches also affects the regulation of the output current or voltage 230 and changing the duty cycle used to drive the switches also affects the power factor of the input of the DC-DC converter. In this embodiment, the MIMO controller 305 may include a frequency controller function and a duty cycle controller function and may be programmed to operate the frequency controller and a duty cycle controller functions together and to calculate frequency and duty cycle values that are decoupled so that the error signal 250 does not affect the regulation of the output current or voltage 230 and the error signal 255 does not affect the input power factor. In other embodiments, the frequency and duty cycle values are decoupled so that the error signal 250 only affects the input power factor and the error signal 255 only affects regulation of the output current or voltage 230.

The MIMO controller 305 may also include an optimizer function 320 for optimizing the voltage Vb across the bulk capacitor 115 (FIG. 1). As mentioned above, more than one combination of frequency and duty cycle may produce the same input power correction and output regulation. However, a unique combination of frequency and duty cycle may be selected to control Vb. For example, Vb should be maintained above a certain voltage in order to ensure the discontinuous conduction mode operation, however, a substantially higher voltage may cause the bulk capacitor 115 to become overstressed. It may also cause much higher RMS currents in Q1 and Q2, resulting in inefficient operation. The optimizer function 320 may determine a combination of frequency and duty cycle values that provides input power factor control, output power regulation, while at the same time providing a lower Vb that still maintains discontinuous conduction mode operation at the input.

In at least one aspect, the MIMO controller 305 may be implemented as a digital controller 310 under the control of one or more programs stored on computer readable media, for example, memory 315. In other embodiments, the Multiple Input Multiple Output Controller 305 may be implemented as any combination of analog and digital components.

Decoupling of the frequency and duty cycle values may be accomplished using various methods. An exemplary method may start by developing an average model of the Integrated Boost Asymmetrical Half Bridge (IBAHB) as shown in FIG. 1.

A pertinent set of 6 state-space variables may be recognized from the topology of FIG. 1:

Iin Current through input inductor Lin

Vc1 Voltage across upper Half-Bridge Capacitor

Vc2 Voltage across lower Half-Bridge Capacitor

Im Magnetizing current of the transformer

Io Current through output inductor Lo

Vo Voltage across output capacitor Co

Other parameters include:

Vin Input voltage

Vb=(Vc1+Vc2) Bulk (or boost) voltage

N1, N2 Transformer turns ratios

C1, C2 Values of Half bridge capacitors

Lin Value of input inductance

Lm Value of magnetizing inductance

Lo Value of output inductance

Co Value of output capacitance

D Duty Cycle

T Period (Reciprocal of Frequency)

The following average model for the IBAHB may be derived using state-space averaging:

$$\begin{matrix} Iin = \frac{Vin}{2 Lin} \cdot {D}^{2} \cdot T \cdot ( \frac{Vc 1 + Vc 2}{Vc 1 + Vc 2 - Vin} ) & ( 1 ) \\ \frac{d}{d t} Vc 1 = [ \frac{{( Vin \cdot D )}^{2} \cdot T}{2 Lin \cdot ( Vc 1 + Vc 2 - Vin )} - ( Im + Io \cdot N 1 ) \cdot ( 1 - D ) ] \cdot \frac{1}{C 1} & ( 2 ) \\ \frac{d}{d t} Vc 2 = [ \frac{{( Vin \cdot D )}^{2} \cdot T}{2 Lin \cdot ( Vc 1 + Vc 2 - Vin )} + ( Im - Io \cdot N 2 ) \cdot D ] \cdot \frac{1}{C 2} & ( 3 ) \\ \frac{d}{d t} Im = [ Vc 1 \cdot ( 1 - D ) - Vc 2 \cdot D ] \cdot \frac{1}{Lm} & ( 4 ) \\ \frac{d}{d t} Io = [ Vc 2 \cdot N 2 \cdot D + Vc 1 \cdot N 1 \cdot ( 1 - D ) - Vo ] \cdot \frac{1}{Lo} & ( 5 ) \\ \frac{d}{d t} Vo = ( Io - \frac{Vo}{Ro} ) \cdot \frac{1}{Co} & ( 6 )\end{matrix}$$

One possible decoupling strategy is to define two new control variables and Control variable relates to the output current in the following way:

$$α = \frac{d}{d t} Io$$

Thus, equation (5) of the average model can be re-written:

$$α = [ Vc 2 \cdot N 2 \cdot D + Vc 1 \cdot N 1 \cdot ( 1 - D ) - Vo ] \\ or \\ D = \frac{α \cdot Lo + ( Vo - N 1 \cdot Vc 1 )}{N 2 \cdot Vc 2 - N 1 \cdot Vc 1} \qquad ( 7 )$$

Control variable relates to the input current in the following way:

β=Iin

Thus, equation (1) of the average model can be re-written:

$$β = \frac{Vin}{2 Lin} \cdot {D}^{2} \cdot T \cdot ( \frac{Vc 1 + Vc 2}{Vc 1 + Vc 2 - Vin} ) \qquad ( 8 )$$

Note that only relates to output current while only relates to input current. Therefore these two variables are decoupled. In other words, while the original control variables D and T affect both the input and the output currents (they are coupled), certain combinations of D and T defined as and above are fully decoupled.

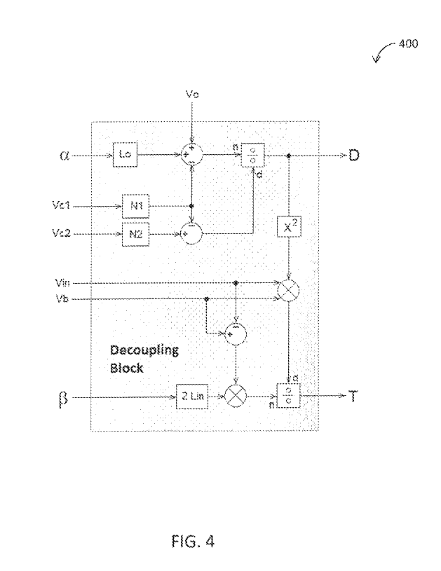

The decoupling function will therefore attempt to reconstruct duty cycle D and frequency 1/T, based on the equations for and FIG. 4 shows a graphical representation 400 of equations (7) and (8) as they are used to derive the duty cycle D and T which equals the reciprocal of the frequency. FIG. 4 also illustrates operations of a controller in order to decouple the frequency and duty cycle values.

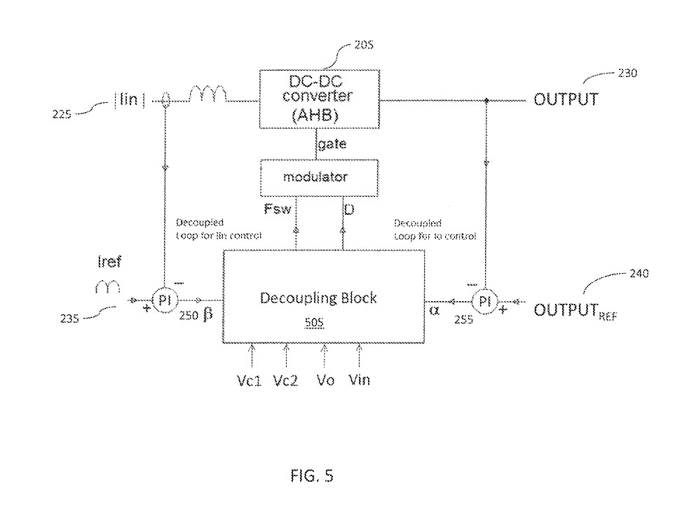

FIG. 5 illustrates a version of the MIMO controller 505 that includes the decoupling block 400 of FIG. 4. As illustrated in FIG. 5, control variable controls the decoupling block as error signal 255 and control variable controls the decoupling block as error signal 250, and inputs Vc1, Vc2, Vo, and Vin are provided from the DC-DC converter 205 as shown in detail in FIG. 1.

The disclosed embodiments provide precise control of both input and output characteristics in a single power stage converter. Previous solutions only approximately control either the input power factor or the output regulation, typically by varying the duty cycle. The disclosed embodiments also provide for controlling additional internal variables for better performance or reliability, for example, the bulk capacitor can be subjected to a minimum voltage, which may result in improved reliability and also improved efficiency of the switching operations.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Furthermore, some of the features of the exemplary embodiments could be used to advantage without the corresponding use of other features. As such, the foregoing description should be considered as merely illustrative of the principles of the disclosed embodiments and not in limitation thereof.

1. A method of operating a DC-DC converter comprising:
providing a first error signal to a frequency controller, the first error signal derived from a difference between a discontinuous conduction mode input current and a sinusoidal current reference;
providing a second error signal to a duty cycle controller, the second error signal derived from a difference between an output signal and an output reference signal; and
combining a frequency signal from the frequency controller and a duty cycle signal from the duty cycle controller to produce a complimentary pulse train for driving the DC-DC converter to both control an input power factor and regulate the output signal.

2. The method of claim 1, comprising using the frequency controller to generate the frequency signal from the first error signal.

3. The method of claim 1, comprising using the duty cycle controller to generate the duty cycle signal from the second error signal.

4. The method of claim 1, comprising:
operating the frequency and duty cycle controllers together as a multiple input multiple output controller; and
using the multiple input multiple output controller to calculate frequency and duty cycle values that are decoupled so that the first error signal does not affect the regulation of the output signal and the second error signal does not affect the input power factor.

5. The method of claim 1, comprising:
operating the frequency and duty cycle controllers together as a multiple input multiple output controller; and
using the multiple input multiple output controller to calculate frequency and duty cycle values that are decoupled so that the first error signal only affects the input power factor and the second error signal only affects the regulation of the output signal.

6. The method of claim 5, comprising:
optimizing a value of a voltage across a bulk capacitor of the DC-DC converter by determining a combination of frequency and duty cycle values that controls the input power factor control, output power regulation, while providing a voltage across the bulk capacitor that maintains a discontinuous conduction mode operation.

7. A DC-DC converter comprising:
a frequency controller configured to receive a first error signal derived from a difference between a discontinuous conduction mode input current and a sinusoidal current reference;
a duty cycle controller configured to receive a second error signal derived from a difference between an output signal and an output reference signal; and
a modulator configured to combine a frequency signal from the frequency controller and a duty cycle signal from the duty cycle controller to produce a complimentary pulse train for driving the DC-DC converter to both adjust an input power factor and regulate the output signal.

8. The DC-DC converter of claim 7, wherein the frequency controller is configured to generate the frequency signal from the first error signal.

9. The DC-DC converter of claim 7, wherein the duty cycle controller is configured to generate the duty cycle signal from the second error signal.

10. The DC-DC converter of claim 7, comprising:
a multiple input multiple output controller comprising the frequency and duty cycle controllers, wherein the multiple input multiple output controller is configured to calculate frequency and duty cycle values that are decoupled so that the first error signal does not affect the regulation of the output signal and the second error signal does not affect the input power factor.

11. The DC-DC converter of claim 7, comprising:
a multiple input multiple output controller comprising the frequency and duty cycle controllers, wherein the multiple input multiple output controller is configured to calculate frequency and duty cycle values that are decoupled so that the first error signal only affects the input power factor and the second error signal only affects the regulation of the output signal.

12. The DC-DC converter of claim 11, comprising:
an optimizer configured to optimize a value of a voltage across a bulk capacitor of the DC-DC converter by determining a combination of frequency and duty cycle values that controls the input power factor control, output power regulation, while at the same time providing a voltage across the bulk capacitor that maintains a discontinuous conduction mode operation.
